(19) United States
(12) Patent Application Publication
(10) Pub. No.: US 2012/0249595 A1
(43) Pub. Date: Oct. 4, 2012

(54) AREA SELECTION FOR HAND HELD DEVICES WITH DISPLAY

(76) Inventor: David Y. Feinstein, Bellaire, TX (US)

(21) Appl. No.: 13/183,199

(22) Filed: Jul. 14, 2011

Related U.S. Application Data
(60) Provisional application No. 61/470,444, filed on Mar. 31, 2011.

(51) Int. Cl. G09G 5/34

(52) U.S. Cl. 345/642

(57) ABSTRACT

Systems and methods for selecting an area from the virtual display of a hand held device with a touch screen display and a tilt and movement sensor are provided. View navigation during regular operation is performed by touch screen commands and tilt and movement gestures. During area selection operation, all touch screen commands that perform view navigation or links activation are suspended, limiting touch commands to perform only boundary corner selections. The virtual display may be navigated using the tilt and movement sensor during area selection operation. This eliminates unintended touch commands that may inadvertently change the display during the area selection. The user may perform accurate repositioning of corners or markers placed on the touch screen display by using touch control or tilt and movement gestures. The boundary of the selected area can be automatically adjusted to reduce the affect of unwanted truncation of contents.

### CROSS-REFERENCE TO RELATED APPLICATIONS

This application claims the benefit of provisional patent application Ser. No. 61/470,444, filed 2011 Mar. 31 by the present inventor, which is incorporated by reference.

### STATEMENTS REGARDING FEDERALLY SPONSORED RESEARCH OR DEVELOPMENT

Not applicable.

### REFERENCE TO A MICROFICHE APPENDIX

Not applicable

### BACKGROUND OF THE INVENTION

1. Field of the Invention

The present invention generally relates to hand held devices with display, and more particularly to the process of selecting a desired area, a marker position, or multiple objects from the contents view associated with the display of the hand held devices.

2. Description of the Related Art

In this specification, I refer to the Area Selection operation as the common user activity performed on information processing devices with visual displays for the purpose of defining and selecting a portion of the contents of a displayed file, or for the purpose of selecting multiple objects represented by icons on the display. The contents of the displayed file may be graphical, text, media, or any other type of data that may be displayed on the device's display.

Area selection within the contents of a displayed file is typically associated with many user interface functions, including Cut and Paste, Drag and Drop, Copy, Highlight, Zoom in, and Delete. Both the Cut and Paste and Copy operations are used to select a portion of the display and copy it into another place of the same display or via the common clipboard onto other active or inactive applications of the device. The Cut and Paste operation causes the originally selected area to be deleted while the Copy operation preserves the originally selected area. The area selection operation within a graphical file is typically selected within a bounding rectangle whose two corners are specified by the user. For text documents, the area selection is a block selection operation, where the selected block is defined between two user selected endpoints placed at two character positions within the text.

For some applications, the area selection operation highlights a portion of the display which is then used as an input for some processing (e.g. speech synthesis, graphical processing, statistical analysis, video processing, etc.). Area selection can be also used to select multiple objects that are not part of a single file, where the individual graphic objects are represented by icons spread across the display.

Desktop systems typically use a pointer device like a mouse or a joystick to select the cut and paste area. Other common techniques include touch screen and voice control selections. When selecting a block of text one can often use pre-assigned keyboard commands.

Hand held devices with a small physical display often must show a virtual stored or a computed contents view that is larger than the screen view of the physical display. Since only a portion of the contents display (also called “virtual display”) can be shown at any given time within the screen view, area selection on hand held devices poses more of a challenge than desktop area selection. This is particularly the case when the desired selected area from the virtual display is stretching beyond the small screen view.

Today's most popular user interface in hand held devices is the touch screen display. The touch screen display enables the user to create single-touch and multi-touch gestures (also called “touch commands”) to navigate (or “scroll”) the display as well as to activate numerous functions and links. There are two main limitations for the touch screen display area selection operation: the setting of the area corners, and the placement accuracy due to the relatively wide finger tip.

When setting area corners for a selected area by touch gestures, one encounters the problem that the touch gesture may inadvertently navigate the screen (or follow a link) instead of placing the corner. Alternatively, touch gestures intended for view navigation may be confused for corner selection during the process. This problem is currently solved by training the user to perform precise and relatively complex touch gestures that attempt to distinguish between navigation commands and corner placement commands. This further poses a major disadvantage for most users who must spend the time to gain expertise in the precise handling of their device touch interface.

U.S. Pat. No. 7,479,948 by Kim et al. describes a method for area selection using multi-touch commands where the user touches simultaneously with several fingers to define a selected area. These unique multi-touch commands limit confusion with view navigation commands, but they are cumbersome and require extensive user training This approach seems to be limited for a selected area that is small enough to be fully enclosed within the screen view of the display. The complexity of using touch commands for area selection is further illustrated in US patent application 2009/0189862 by Viberg, where the operation of moving a word is facilitated into a complex four touch operation.

Another approach that utilizes complex touch gestures is illustrated in the article “Bezel Swipe: Conflict-Free Scrolling and Multiple Selection on Mobile Touch Screen Devices” by V. Roth and T. Turner, In CHI 2009, Apr. 4-9, 2009, Boston, Mass., USA. Bezel Swipe requires an initial gesture that starts with the bezel, a touch insensitive frame around the boundary of the display. From that point, the user touches the screen and moves the finger to select the desired area, ending the selection process by lifting the finger. Solutions like the Bezel Swipe and the patents mentioned above are particularly cumbersome when the desired selected area or objects span beyond the boundaries of the display. Often selection errors are inadvertently made and the user must re-do the selection process.

Touch based area selection of the prior art also face the problem of inaccurate corner points positioning due to the wide contact area between the user's finger and the screen. Stylus devices with sharp tips have been well known to provide accurate positioning of selection points. US patent application 2010/0262906 by Li attempts to solve the problem of distinguishing between area selection commands and view navigation commands. It proposes a special stylus that has a built in key that transmits a special instruction to the device to perform a selection and copy command at the area touched by the stylus. US patent application 2008/0309621 by Aggarwal et al. teaches the use of a proximity based stylus which can interact with the device screen without necessitating that the stylus makes physical contact with the display. The area selection process is started by making a physical contact between the stylus and the display at one corner of the desired selected area. The user then hovers the stylus slightly over the display to navigate to the other corner of the selected area. The two preceding patent applications are disadvantaged by the need of a special active stylus, and they do not perform well when the selected area is much larger than the size of the screen.

U.S. Pat. No. 7,834,847 by Boillot et al. offers a touch-less control of the screen of a mobile device using a sensing system for detecting special movement of the user's fingers in the space above the display. The patent teaches the use of special finger gestures to initiate area selection and cut and paste operations. This solution requires a complex and expensive system for detecting the touch-less finger gestures and it burdens the user with the need of extensive gesture training, which is still prone to errors.

Area selection in hand held devices can be made also by a joystick or special keyboard, as illustrated in US patent application 2006/0270394 by Chin, which uses a multi-stage hardware button to activate special functions like cut and paste. The need of activating different positions of the button creates cumbersome user interface as the button needs continuously be switched from selection mode to view navigation mode.

The view navigation system of a mobile device may utilize a set of rotation and movement sensors (like a tri-axis accelerometer, gyroscope, tilt sensor, camera tilt detector, or magnetic sensor). An early tilt and movement based view navigation system is disclosed in my U.S. Pat. Nos. 6,466,198 and 6,933,923 which have been commercialized under the trade name RotoView. This system is well adapted to navigate the device's screen view across an arbitrarily large contents view and it provides coarse and fine modes of navigation. At fine mode navigation, relatively large orientation changes cause only small view navigation changes. Conversely, at coarse navigation mode, relatively small orientation changes cause large view navigation changes. Later examples include U.S. Pat. No. 7,667,686 by Suh which shows how a selected area from a virtual display may be dragged and dropped. However, the '686 patent completely ignores the problem of area selection which is central to the present invention.

Therefore, it would be desirable to provide methods and systems that can perform area selection on hand held devices with display without the need of sophisticated stylus devices, proximity detectors, or special buttons. Furthermore, it should not require extensive user training and it should be accurate and error free when selecting areas that are either smaller or larger than the display size.

### BRIEF SUMMARY OF THE INVENTION

With these problems in mind, the present invention seeks to provide intuitive, convenient, and precise area selection techniques for hand held devices with a small display.

In one embodiment of the present invention, a hand held device with touch screen display uses a combination of both touch screen gestures and tilt and movement based view navigation modes. For normal operation, view navigation can be made by various touch gestures or by tilt and movement based view navigation. During the area selection operation, the device reserves the touch commands only for the selection of the corner points of the selected area. Once the first corner is selected, the device uses tilt and movement view navigation exclusively to reach the general area of the second corner. Once the area of the second corner is reached, the user completes the area selection by touching the desired second corner. This guarantees that corner selection touch gestures may not be wrongly interpreted as view navigation commands.

If the contents view displays text only, the area selection is essentially enclosed between two endpoints along the text. The present invention simplifies the tilt and movement based view navigation to correlate the three dimensional tilt and movement gestures into a linear up/down move along the text and setting the endpoints for the selected text at words boundaries.

In yet another embodiment of the present invention, a special touch gesture provides both initiation of the area selection operation as well as the actual selection of the first corner of the selected area.

The present invention also offers marker repositioning techniques to allow precise adjustment of the corner locations that are placed by the relatively inaccurate touch commands that use the relatively wide finger tip. These techniques can be used to reposition any marker set by a touch command.

Another embodiment of the present invention offers a method for boundary adjustment of a user selected area to reduce the affect of unwanted truncation of contents. Such a contents aware method offers the user an automatic boundary adjustment choice at the end of the area selection process to eliminate the need to repeat the entire process.

These and other objects, advantages, and features shall hereinafter appear, and for the purpose of illustrations, but not for limitation, exemplary embodiments of the present invention are described in the following detailed description and illustrated in the accompanying drawings.

### BRIEF DESCRIPTION OF THE SEVERAL VIEWS OF THE DRAWINGS

The drawings are not necessarily drawn to scale, as the emphasis is to illustrate the principles and operation of the invention. In the drawings, like reference numerals designate corresponding elements, and closely related figures have the same number but different alphabetic suffixes.

FIG. 1 shows an example of contents view with a defined selected area.

FIG. 2A to FIG. 2D detail the process of marking the selected area from the contents view shown in FIG. 1 in accordance with one embodiment of the present invention.

FIG. 3 illustrates the block diagram of the embodiment of a hand held device with touch screen display incorporating the present invention.

FIG. 4A outlines the software flow diagram for the embodiment of the invention for selecting an area from a general contents view.

FIG. 4B outlines the software flow diagram for another embodiment of the invention for selecting an area from a general contents view.

FIG. 5 shows the process of selecting a block of text with another embodiment of the present invention.

FIG. 6 outlines the software flow diagram for the process of selecting a block of text in the embodiment of the invention shown in FIG. 5.

FIG. 7A to FIG. 7C show the use of auto-displaced corner points to allow precise corner repositioning of the selected area.

FIG. 8 outlines the software flow diagram for corner repositioning of the selected area using tilt and movement based view navigation set at fine mode in another embodiment of the present invention.

FIG. 9A and FIG. 9B show another embodiment of the present invention that performs contents aware boundary adjustment of the selected area.

FIG. 10 shows the software flow diagram for the automatic boundary adjustment of the selected area in the embodiment of the invention shown in FIG. 9.

FIG. 11 shows the software flow diagram for the extension of the corner repositioning technique of FIG. 8 to a general marker repositioning on a mobile touch screen display.

### DETAILED DESCRIPTION OF THE INVENTION

Hand held devices have typically small screens and often need to show information contents that are larger than the size of their displays. They employ a virtual display (also called “contents view”) which is stored in the device memory, while a part of the virtual display is shown in the physical display (“screen view”). In many systems, the virtual display may be dynamically downloaded to the device (e.g. from the internet or externally connected devices) so that at various times only a part of the virtual display is actually stored in the device.

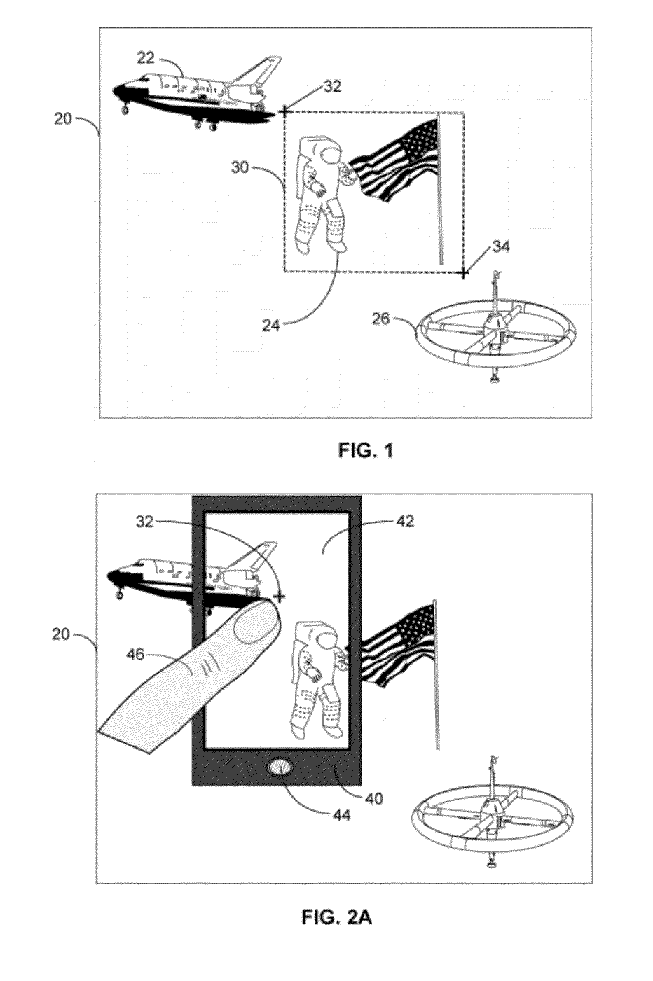

FIG. 1 shows an example of a virtual display 20 which contains several graphic items 22, 24 and 26. In a typical area selection operation, the user must define a selected area 30 by depicting two opposite corners 32 and 34 of a rectangular boundary. Two opposite corners define a unique rectangular boundary, provided the base of the rectangle is parallel to the bottom line of the display. Traditionally, such rectangular boundaries are used in most area selection operations in computer systems. Therefore, throughout this specification and the appended claims, it is assumed that any pair of selected area corners are used as opposite corners for a rectangular selected area boundary whereby the base of the boundary is parallel to the bottom of the display. In general, other geometrical shapes may be used as boundaries for unique area selection operations. Such non-rectangular shapes also require a set of defining points, so the teaching of this invention can be trivially extend for non-rectangular boundaries. In the example of FIG. 1, the selected area 30 captures only the graphic item 24 which includes the astronaut and the flag.

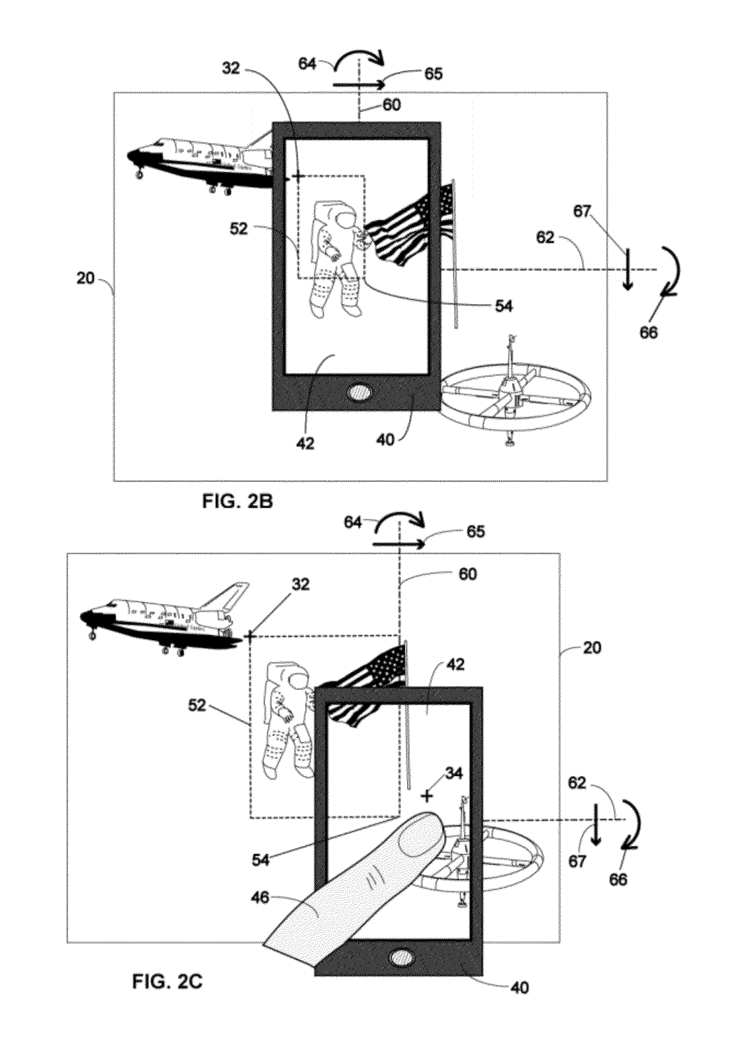

FIG. 2A-FIG. 2D illustrate the process of marking the selected area 30 on the virtual display 20 in the example of FIG. 1 on a hand held device 40 that incorporates one embodiment of the present invention. The hand held devices of the present invention are capable to respond to user's touch gestures as well as to perform tilt and movement based view navigation. Touch gestures (also called “touch commands” in this specification and the appended claims) are detected by the touch screen display 42 which is responsive to the touch of one finger (single-touch) or multiple fingers touch (multi-touch) on the screen. The touch commands can perform view navigation (e.g. display scrolling), as well as many other specific control commands. In the present invention, all touch commands are partitioned into two sets. The first set includes all the view navigation touch commands, and the second set includes all the other touch commands that do not affect view navigation. In this specification I refer to the first set of view navigation touch commands as “TOUCH NAV”. TOUCH NAV commands may include scrolling by flicks, swipes, touch and drag, and other commands. They also include all touch commands that activate links embedded in the screen view, since the activation of the embedded links can change the current view.

The present invention also incorporates tilt and movement based view navigation, like the system disclosed in my U.S. Pat. Nos. 6,466,198 and 6,933,923 which have been commercialized under the trade name RotoView. Tilt and movement based view navigation essentially translates the user's three-dimensional tilt and movements of the hand held device 40 into scrolling commands along two generally perpendicular axes placed on the surface of the display. Tilt and movement gestures can also be used to move a cursor on the screen. Optional button 44, voice commands, joystick, keyboard, camera based visual gesture recognition system, and other user interface means may be incorporated on the hand held device 40.

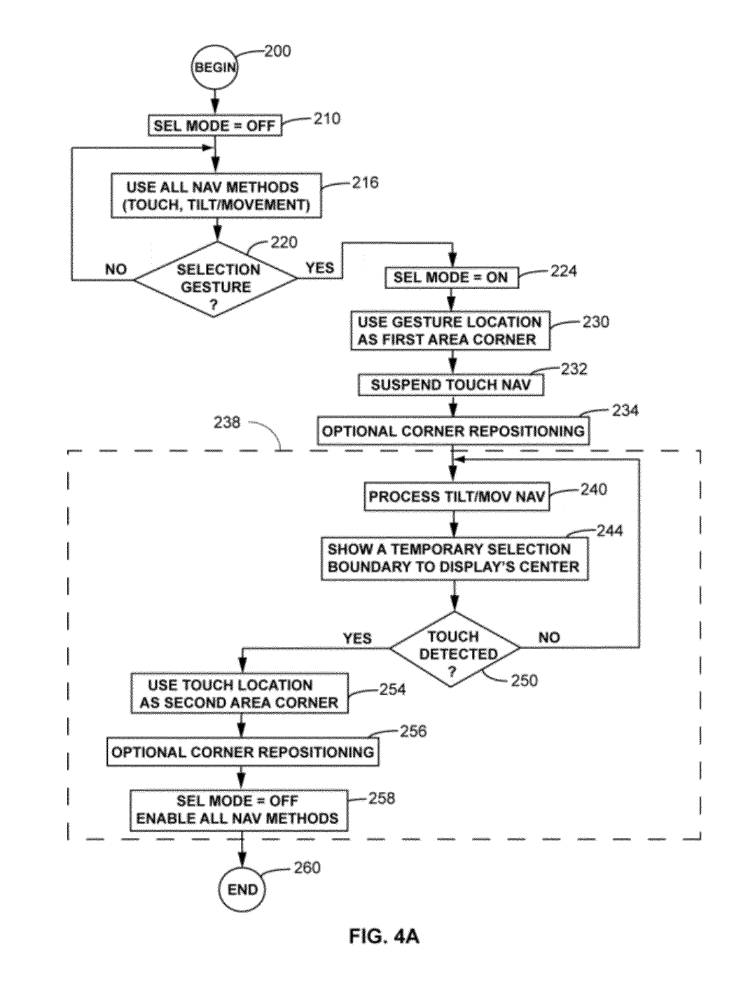

In FIG. 2A, the user can employ any view navigation method available on the device 40 (e.g. TOUCH NAV, tilt and movement based view navigation, or joystick/keyboard scrolling) to navigate the screen view 42 to arrive at the general area of the first corner point 32 of the desired selected area 30 (defined in FIG. 1). The user activates the area selection process by a variety of means that may include a specific touch (or multi-touch) gesture, a voice command, a keyboard command, a visual gesture that may be detected by camera or proximity sensors, or a movement gesture (e.g. device shake). The display may respond with some marker or other indicator to show that the system entered the area selection mode. During the area selection mode, all TOUCH NAV commands must be suspended, leaving only the tilt and movement based view navigation active. This eliminates the problem of misinterpreted touches that may be confused as TOUCH NAV commands instead of corner selection commands. The user then touches the first corner point 32 of the desired selected area with her finger 46 in order to select it. In other embodiments of the present invention, the user's selection command may be a touch gesture which also defines the first area corner 32, as it will be described in FIG. 4A. The accuracy of the corner placement can be increased by employing the corner repositioning method that will be described below.

FIG. 2B shows how tilt movement based view navigation is exclusively used for changing the temporary selection boundary 52. As the user tilts or moves the device 40 in three-dimensional space, the system translates these orientation changes or movements into scrolling commands along two generally perpendicular rotation axes. Borrowing from avionics terminology, we say that axis 60 is set along the roll axis of the device 40. In this example we show one technique which merely ignores any rotation changes along the axis perpendicular to the plane of the screen view and use only pitch and roll data. Various other techniques to translate absolute tilt changes and movements in real three dimensional space onto the two dimensions of the screen view are known in the art, and they can be employed with the present invention. The device uses first rotation axis 60 (along the roll axis of the device 40) to translate device tilt changes and lateral movements along arrow 64 into rightwards horizontal scrolling of the screen view 42 relative to the virtual display 20. Similarly, the second rotation axis 62 is set along the pitch axis of the device 40 and is used to translate device tilt changes and lateral movements along arrow 66 into downwards vertical scrolling. Arrow 65 represents horizontal lateral movement that may be used to scroll the screen view to the right. Similarly, Arrow 67 represents vertical lateral movement that may be used to scroll the screen view down. While the device is manipulated by the user, the first corner of the temporary selection boundary 52 remains anchored to the first corner point 32 on the virtual display 20. The second corner 54 of the temporary selection boundary 52 propagates at around the screen view center. The temporary second corner 54 can be rigidly fixed at the screen view center or may be dynamically “pulled” (with some small time delay) towards the center while the screen view navigates the virtual display. At the stage shown in FIG. 2B, only a small section of the desired selected area is now enclosed within the temporary selection boundary 52.

At FIG. 2C, the temporary second corner 54 has been brought close to the desired second corner location 34. Once the user sees the desired corner location 34 within the screen view, she touches the location 34 to complete the area selection process, as shown in FIG. 2D. Since all TOUCH NAV commands are suspended, any touch sensed by the touch screen display is safely interpreted as a corner selection command. Once the system receives the touch command at location 34, the temporary second corner position 54 at the center of the display flips to location 34. This creates the desired selected area within the rectangular boundary 30, and the system exits the area selection mode. This in turn reactivates the TOUCH NAV commands, allowing the user to perform touch screen based view navigation (swipe, flicks, etc.). The selected area is now available to the calling application program (cut and paste, move, copy, zoom in, etc.). To increase user friendliness of the system, the final selected area 30 may be drawn differently on the screen (color wise, style wise) compared to the temporarily boundary 52. The corner markers 32 and 34 may be removed from the final selected area at the end of the area selection process.

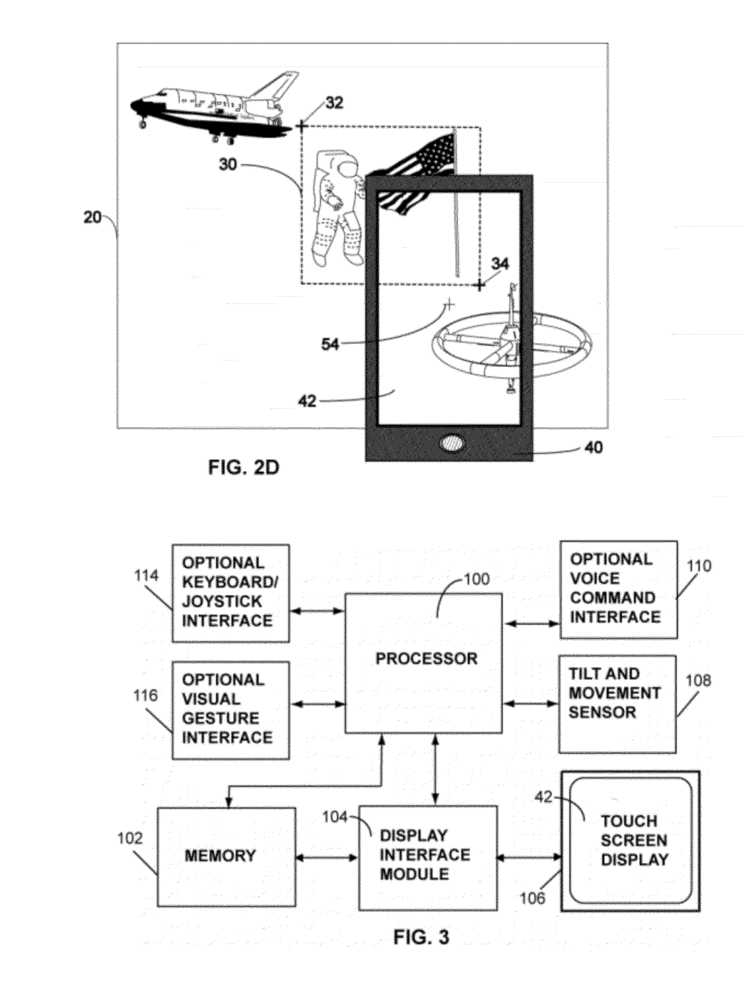

FIG. 3 discloses an embodiment of a hand held device with a touch screen display incorporating the area selection methods of the present invention. The processor 100 provides the processing and control means required by the system, and comprises at least one microprocessor or micro-controller. The processor 100 uses the memory subsystem 102 for retaining the executable program, the data and the display information. A display interface module 104 controls the touch screen display 106 which provides the screen view 42 to the user. The display interface module 104 is controlled by the processor 100 and further interfaces with the memory subsystem 102 for accessing the virtual display and creating the screen view 42. The display interface module may include local graphic memory resources. The display interface module 104 also provides the processor 100 with touch screen gestures made by the human operator (“user”) of the hand held device. Such touch screen gestures may be made by one or more fingers.

A tilt and movement sensor 108 interfaces with the processor to provide ballistic data relating to the movements and rotations (tilt changes) made by the user of the device. The ballistic data can be used by the micro-controller to navigate the screen view 42 over the virtual display 20. The ballistic data can also be used for cursor movement control. Typically, the tilt and movement sensor 108 comprises a set of accelerometers and/or gyroscopes with signal conversion for providing tilt and movement information to the processor 100. A 6-degree-of-freedom sensor, which comprises a combination of a 3-axis accelerometer and 3-axis gyroscope can be used to distinguish between rotational and movement data and provide more precise view navigation. It should be pointed out that tilt and movement based navigation can be implemented with only accelerometers or with only gyroscopes. Other tilt and movement sensors may be mechanical, magnetic, or may be based on a device mounted camera associated with vision analysis to determine movements and rotations.

The processor 100 can optionally access additional user interface resources such as a voice command interface 110 and a keyboard/joystick interface 114. Another interface resource may be a visual gesture interface 116, which detects a remote predefine visual gesture (comprising predefined movements of the hand, the fingers or the entire body) using a camera or other capture devices. It should be apparent to a person familiar in the art that many variants of the block elements comprising the block diagram of FIG. 3 can be made, and that various components may be integrated together into a single VLSI chip.

FIG. 4A illustrates the software flow diagram of one embodiment of the present invention that performs the area selection process shown in FIG. 2. The process connects to the regular operating system flow at the beginning step 200 by a parent application that needs area selection. It first resets the selection mode to indicate normal operation mode at step 210. At steps 216 and 220, the user navigates the virtual display to select the first area corner 32. As shown in step 216, the user can use any view navigation method available at the device during normal operation mode, including touch screen view navigation (TOUCH NAV) and tilt and movement based view navigation (TILT/MOV NAV). Step 216 also represents all other non related device operations, including all sub-processes of the parent application. At step 220 the system checks if a predefined touch gesture to enter the area selection operation has been detected. For example, such a predefined touch gesture may be an ‘x’ shape finger movement on the display where the ‘x’ center is at the desired location for the first corner of the selected area. If step 220 does not detect a selection gesture, the regular operation of the device continues along step 216.

If step 220 detects a selection touch gesture, the area selection mode is activated at step 224, which may optionally activate a selection indicator or marker on the display, alerting the user that the device is in area selection mode. At step 230 the system converts the gesture defined touch location (e.g., the center point in an ‘x’ shape touch gesture) as the first corner 32 of the selected area at the exact touch location on the portion of said virtual display currently shown on said touch screen display. Once the first area corner 32 is selected, step 232 suspends the set of the TOUCH NAV commands, allowing the tilt and movement based view navigation to work during the following selection of the second corner of the selected area. The suspension of the TOUCH NAV commands is crucial to insure that any kind of touch detection in the following steps will be interpreted solely in the correct context of the area selection process. Step 234 offers an optional corner repositioning that can achieve more precise positioning of the area corner. The optional corner repositioning is described in greater detail below. Optional joystick or keyboard based view navigation may be also allowed to work along with the tilt and movement based view navigation during the area selection process.

The sub-process 238 is used to select the second corner 34 of the selected area. The system processes the tilt and movement based view navigation at step 240. At step 244, a temporary selected area boundary 52 is drawn from the first corner 32 onto a temporary corner 54 at the general center of the screen view 42 as it scrolls the virtual display 20 in response to the tilt and movement based view navigation. At step 250 the system checks for any touch command. If a touch command is not detected, the process continues along steps 240 and 244. If a touch command is detected, the touch location is used as the second corner 34 of the selected area at step 254. Step 256 offers the optional corner repositioning sub-process that achieves more precise positioning of the final selected area's corner. The final selected area 30 is drawn on the virtual display 20. At step 258 the selection mode is deactivated and the set of TOUCH NAV commands is reactivated. Finally, the system provides the selected area information to the calling application as the process ends at step 260.

FIG. 4B illustrates the software flow diagram of another embodiment of the present invention to perform area selection. The process connects to regular operating system flow at the beginning step 270 by a parent application that uses the area selection operation. It first resets the area selection mode at step 272 to indicate normal operation mode. The user can employ any view navigation method available at the device during normal operation mode. At step 276, the system continuously monitors for an area selection command which may be initiated by several sources. Such an area selection command can be initiated by a touch or movement gesture, by a voice command, by a keyboard of switch button press, by a predefined visual gesture, or by any other common user interface means. It can also be initiated by the parent application itself in response to its program flow. Step 276 also represents all other device operations, including all sub-processes of the parent application that may need the area selection operation. At step 280 the system determines if an area selection command has been detected. If a selection command is not detected, the regular operation of the device continues along step 276.

If step 280 detects a selection command, the selection mode is activated at step 282 and the set of TOUCH NAV commands is suspended as explained earlier. The system now executes steps 286 and 290 to determine the location of the first corner 32 of the selected area. At step 286, the system scrolls the display by tilt and movement based view navigation to reach the desired virtual display area to place the first corner point. Step 286 may optionally activate a blinking marker or an enlarged crosshair marker on the display's center, alerting the user that the device has entered into the selection mode and a selection of the first corner 32 is needed. At step 290 the system checks if a touch was detected. If a touch is not detected, the user continues to navigate for the location of the first corner 32 at Step 286.

If step 290 detects a touch, the system uses the touch location to place the first corner 32 at step 292. Step 294 offers the optional corner repositioning sub-process that achieves more precise positioning of the selected corner 32. The sub-process 238 of FIG. 4A is now performed at step 296 in order to complete the area selection and provide the calling application with the selected area at the end step 298.

The area selection techniques described above are based on a rectangular boundary that is defined by two opposite corners with a base parallel to the bottom of the display. It should be clear that the teaching of the present invention can be easily extended for area selection that uses other geometrical shapes. In the case of polygon-like shapes that use more than two corners, the extension of the present invention requires orderly repetition of step 238 and 296 in FIGS. 4A and 4B to set all the corners.

It appears that for a small area selection which is fully visible within the screen view, one may perform the processes in FIGS. 4A and 4B with minimal or even no use of the tilt and movement based view navigation (steps 240 and 286). It should be noted that even in this case, the suspension of the TOUCH NAV commands during the area selection is a key feature of the present invention to avoid the unintended activation of touch command that will inadvertently change the view. Also, it is quite common that users perform a zoom in operation prior to the selection of small areas in order to increase the selection accuracy. This zoom in creates a virtual display that is larger than the screen view and requires the tilt and movement based view navigation.

Common applications like word processors require area selection from a virtual display that may contain only text. Some of these applications may have a virtual display 20 with text lines widths which are larger than the width of the screen view 42. In such cases the selection of a text block can be made similar to the embodiments of the present invention shown in FIG. 2 and the associated flow charts in FIG. 4. However, most text applications limit the width of the virtual display to fit the text lines within the screen view so that the user does not need to scroll left and right.

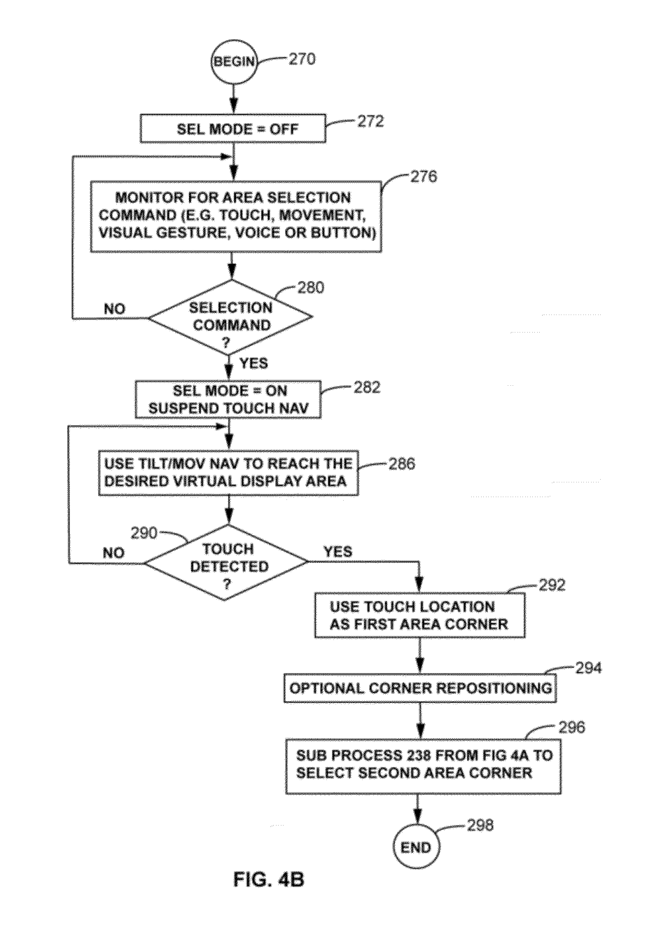

FIG. 5 illustrates another embodiment of the present invention for selecting a block of text from a virtual display 20 that includes lines of text that are fully enclosed within the width of the screen view 42. Although text is spread on a two dimensional area, it is essentially arranged linearly along a single list of characters and spaces which is divided into multiple text lines. As a result, text block selection is defined by two endpoints (e.g. block-start point 70 and block-end point 72) along the list of the characters of the text.

The user initiated the text block selection process by a touch gesture at point 70, when the desired section of the text area was shown in the screen view 42. The touch gesture may be shaped as virtual letter ‘x’ and the first endpoint 70 may be selected as the nearest inter words space to the gesture's ‘x’ center location. The system enters text selection mode where the set of TOUCH NAV commands is suspended and the user can use the tilt and movement based view navigation to scroll the display. As the user scrolls the display downwards, a temporary endpoint 72 is placed at or near the center of the screen view 42, and the text block 74 from the starting endpoint 70 to the temporary endpoint 72 is highlighted. Once the desired second endpoint of the selection block 78 appears anywhere on the screen view, the user touches this endpoint's location, and completes the text block selection process.

Since the virtual display 20 is adjusted to fit the width of the screen view 42, there is no need for horizontal navigation of the temporary endpoint 72. Therefore, it is possible to map the two axes view navigation obtained from the tilt and movement sensor into a single axis corresponding along the character list of the text. For a left to right language like English, both roll rotation 64 to the right and pitch rotation down 66 (or movements to the right 65 and down 67) are translated into a downwards text scrolling. Roll rotation to the left and pitch rotation up are similarly translated into an upwards text scrolling. For a right to left language like Hebrew, both roll rotation 64 to the left and pitch rotation 66 down are translated into downwards text scrolling. Roll rotation to the right and pitch rotation up are similarly translated into an upwards text scrolling. The tilt and movement based view navigation of the present invention is particularly useful when the length of the text block is longer than the height of the screen view 42.

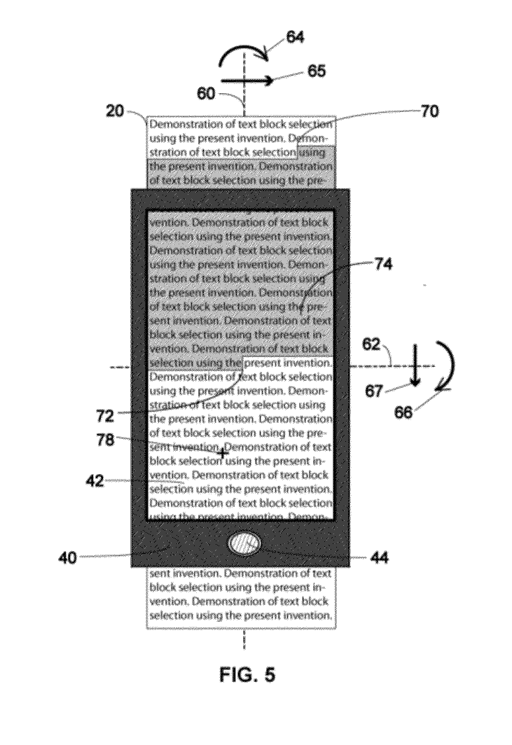

FIG. 6 illustrates the software flow diagram used to compute the text block selection of the system shown in FIG. 5. The process connects to regular operating system flow at the beginning step 300 by a parent application that uses area selection operation. It first resets the text selection mode to indicate normal operation mode at step 310. During normal operation mode 316, the user can use any view navigation method available at the device, including TOUCH NAV and tilt and movement based view navigation. Step 316 also represents all other device operations, including all sub-processes of the parent application that may need area selection. At step 320 the system checks if a selection touch gesture has been detected. For example, such a touch gesture may be an ‘x’ shape finger movement on the display where the ‘x’ center is at the desired first endpoint of the selected block. If no touch gesture is detected, the regular operation of the device continues along step 316.

If step 320 detects a selection gesture, the text selection mode is activated at step 324, which may optionally activate a selection indicator or marker on the display, alerting the user that the device is in a text selection mode. The set of TOUCH NAV commands is suspended at step 324 as explained earlier. At step 328 the system uses the finger touch location (e.g., the center point in an ‘x’ shape touch gesture) as the first endpoint 70 of the text block selection. The system may set the block endpoint at the inter words space nearest to the gesture location.

The system now executes steps 340, 344, 354, 358, 362 and 366 to allow the user to select the second endpoint for the selected block. Steps 340 and 344 detect the user tilt and movement based view navigation commands and steps 354 and 358 respond to these commands by scrolling the text up or down. Assuming the text language is English, if at step 340 the system detects a tilt and movement up or to the left, it scrolls the text list of characters up at step 354. If at step 344 the system detects a tilt and movement down or to the right, it scrolls the text list of characters down at step 358. After each scrolling action, step 362 sets the temporary endpoint 72 generally towards the screen view center and the block of text 74 between endpoints 70 and 72 is highlighted.

At step 366 the system checks for a touch command. If a touch command is not detected, the scrolling process described in the previous paragraph is repeated. Once a touch is detected, the finger touch location is used as the second endpoint 78 of the selected block at step 370. The system may set the endpoint 78 at the inter words space nearest to the finger touch location. The final text block selection is highlighted on the virtual display. At step 374 the text selection mode is deactivated, and the set of TOUCH NAV commands is reactivated. The system provides the selected text block information to the calling process as the process ends at step 380.

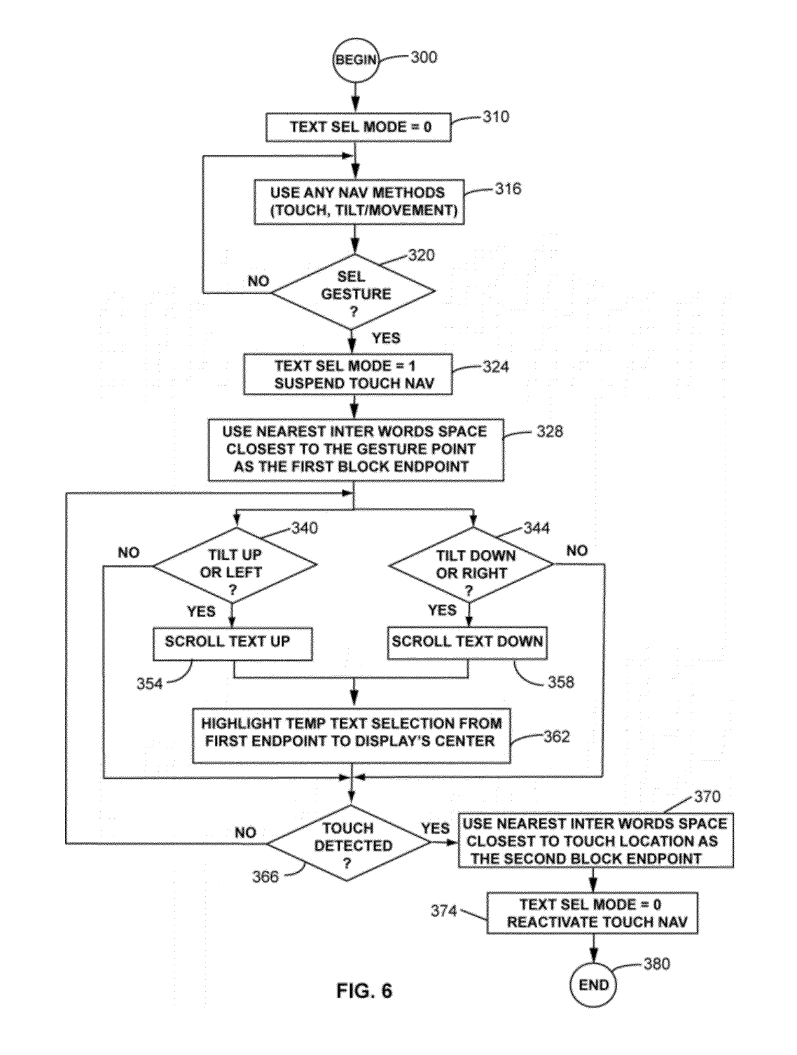

Referring back to FIGS. 2A and 2C, one can appreciate that the user's finger 46 has a substantial size relative to the size of the screen view 42. Therefore, setting the selected area's corner points 32 and 34 by finger touches is not very accurate. FIG. 7A approximates this inherent inaccuracy with an uncertainty area 80 occurring when the user aims to touch a desired point 82 on the screen view 42 of the hand held device 40. The uncertainty area 80 of the finger touch is significantly larger than the uncertainty associated with stylus pointing due to the sharp tip of the stylus. The following embodiments of the present invention offer several corner repositioning techniques that achieve more precise placement of the selected area's corners. The corner repositioning operations are automatically initiated only when the user touches the screen for the actual selection of either the first or second corner points, at steps 234 and 256 of FIG. 4A or at step 294 of FIG. 4B. The corner repositioning operation is not activated when the user performs other touch commands that are not associated with corner placement.

FIG. 7B illustrates an auto-displacement that positions the actual corner point 84 above the actual touch point 82, at a distance sufficient to avoid visual obstruction by the finger 46. When the user first touches the screen at the finger contact point 82 in order to select a corner point, the system enters a corner repositioning mode which remains in effect as long as the user continues to touch the screen. The actual corner point 84 is preferably marked by an increased crosshair cursor (which may be optionally blinking) during the corner repositioning mode to alert the user that the repositioning mode is on, and to enable better repositioning. The movement of the touching finger 46 is translated to the corner point 84, so that any vertical 86 and horizontal 88 movements of the finger cause corresponding vertical 87 and horizontal 89 corner point movements. The direction of the finger movement is translated to a same direction of the displaced corner movement. However, it is possible to achieve higher repositioning accuracy if the length of the movement of the finger is translated into a proportionally smaller length of movement of the displaced area corner. This causes relatively large finger movements to make fine movements of the corner, hence the increased placement accuracy.

When the user reaches the exact corner point position, she lifts her finger 46 from the screen 42, as shown in FIG. 7C. This terminates the corner repositioning mode and the cursor 84 is converted into the final fixed corner point 90, at the exact desired place. If the corner cursor was replaced by a crosshair cursor during the corner repositioning, it is returned to the normal size and shape.

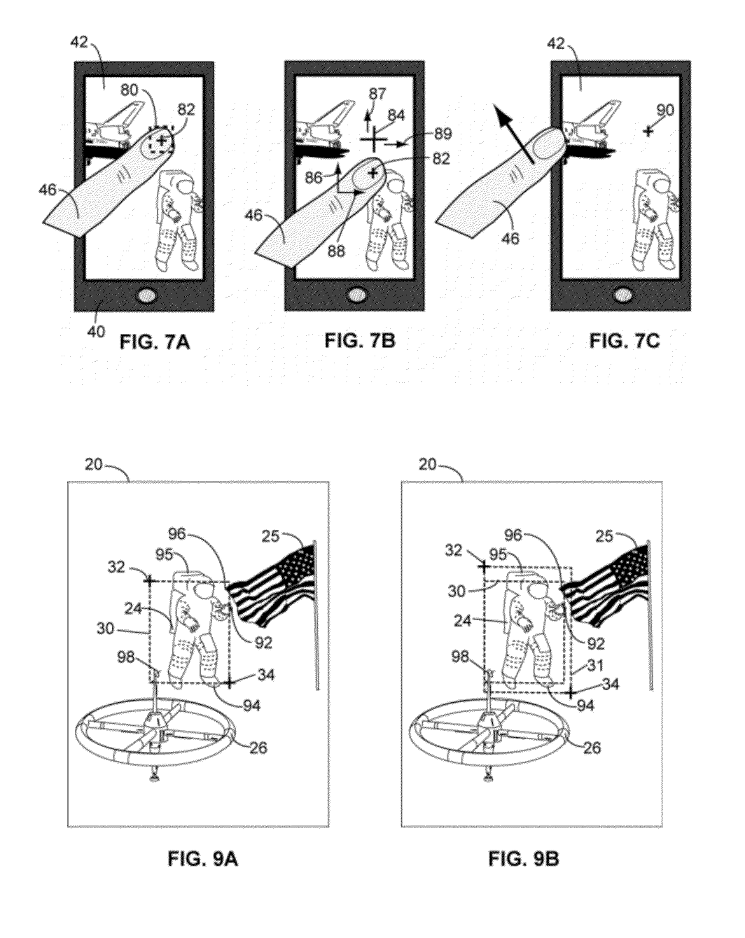

In another embodiment of the present invention, the user can perform corner repositioning using tilt and movement based cursor control set at a fine navigation mode, as illustrated in FIG. 8. The corner repositioning operations are optionally made at steps 234 and 256 of FIG. 4A or at step 294 of FIG. 4B following an initial, relatively inaccurate corner placement by a finger touch. Referring back to FIG. 8, the corner repositioning process begins at step 400 with the currently selected corner. At step 402 the corner repositioning mode is activated, and at step 404 the corner's cursor is replaced with an enlarged crosshair marker at its initial, inaccurate position. Optionally, the enlarged crosshair marker may be set to blink during the corner repositioning mode. This style change in the corner marker provides clear feedback to the user indicating that corner repositioning is on. The enlarged crosshair marker further facilitates more accurate repositioning.

A corner repositioning elapsed timer may optionally be started at step 406. Step 408 activates the tilt and movement based cursor control to move the crosshair marker. The tilt and movement based cursor control is set to fine response mode which translates relatively large tilt and movements of the hand into small movements of the crosshair cursor. The system performs the corner repositioning via the loop of steps 410, 412 and 414. At step 410, the system continuously uses tilt and movement based cursor control set at a fine navigation mode to move the crosshair. Fine navigation mode causes relatively large movements and tilt changes to make fine movements of the crosshair, hence the increased placement accuracy. Corner repositioning mode can be terminated by a touch command, detected at step 412, or at the expiration of the optional timer at step 414.

Once the corner point is placed at the exact desired location, the user touches the screen at the vicinity of the corner point to end the corner repositioning mode by step 412. It should be noted that the exact location of the touch that ends the corner repositioning mode does not change the crosshair marker position. The position of the crosshair marker is fixed and replaced by the final corner at step 416, and the corner repositioning mode is reset at step 418. This completes the repositioning process at step 420.

Another embodiment of the present invention provides automatic boundary adjustment for the area selection to reduce the effect of unwanted truncation of the contents within the selected area. This contents aware area boundary adjustment helps to avoid the need to repeat the area selection process. This embodiment of the present invention is applicable to any computerized system with any type of display where area selection operation is performed.

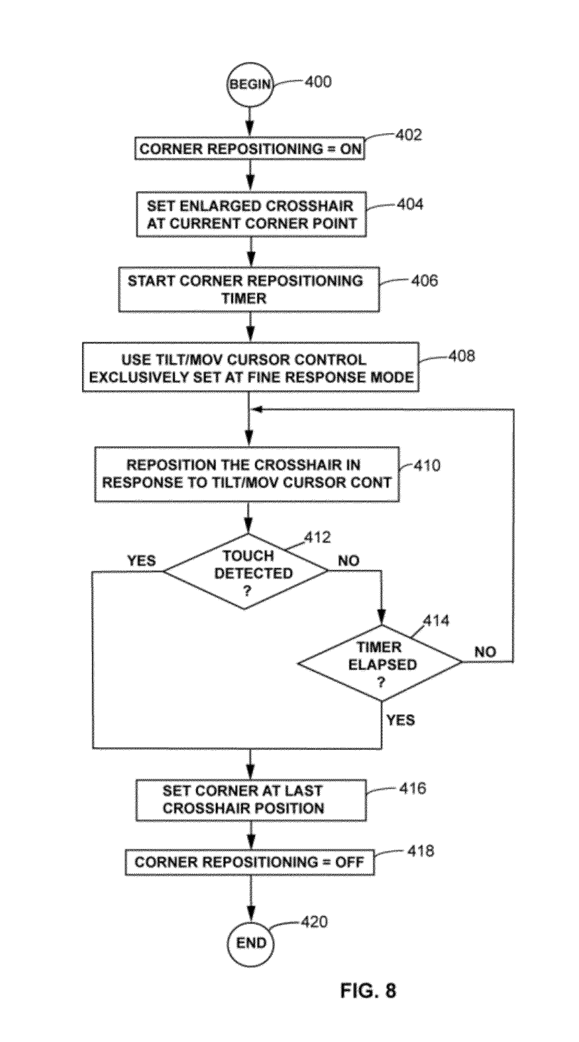

FIG. 9A illustrates a crowded virtual display 20 that includes three graphical objects 24, 25, and 26 at relatively close proximity, assuming that the user wishes to select an area that will contain the astronaut object 24. The selected area 30 performed by the user in FIG. 9A seems to miss some parts of object 24, including portion of the left hand 92, portion of both feet 94, and part of the top 95. Once the area selection 30 is completed with the selection of the second corner point 34, the system automatically determines the truncated portions 92, 94 and 95 of the astronaut object 24. It also detects that a top portion 98 of object 26 and a small corner 96 of the flag 25 have also been truncated.

FIG. 9B shows how the program automatically attempts to adjust the boundary of the selected area 30 with a modified selection area 31 that will properly enclose the main object 24. Using the shapes list analysis described below, the program identify all the truncated shapes. Following a connectivity analysis, the program determines that the truncated shapes 96 and 98 are not connected to the main object at the center of the original selected area 30. The program then continuously increases the height and/or the width of the area selection 30 until the resulting modified boundary 31 encloses all the truncated shapes that deemed connected to the main object. It should be noted that certain truncated shapes may be too large and the system will not be able to enclose them within the modified boundary. If a contents aware correction is not possible, the program aborts with the original selected area 30. If a correction is possible, the system displays both the original selected area 30 and the modified boundary 31 as illustrated in FIG. 9B. The system may need to zoom out the virtual display 20 if the boundaries 30 and 31 go beyond the screen at the current zoom level. The system then prompts the user to accept or reject the modified boundary 31.

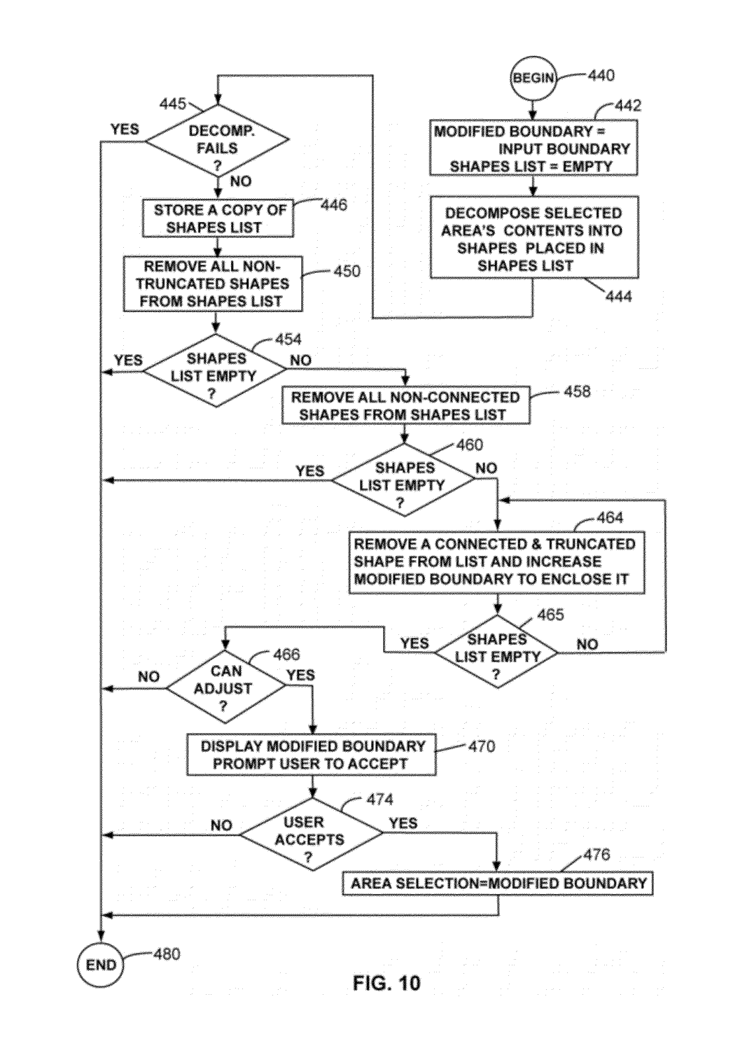

FIG. 10 illustrates the software flow diagram of the program used to perform the automatic contents aware boundary adjustment like the process shown in FIG. 9. The program starts at step 440 following the user completion of an area selection operation as the program is presented with an input area boundary from the selected area. This input area boundary is stored in step 442 as the initial value for the modified boundary, and a recognizable shapes list used for the subsequent decomposition and analysis is emptied. Steps 444, 445, 446, 450, 454, 458, and 460 perform the contents awareness analysis of all objects found within the current boundary.

In step 444, the contents of the input area boundary and its immediate surrounding area are decomposed into recognizable shapes and put into the shapes list. These recognizable shapes include primitive geometric shapes as well as more complex shapes. Complex implementations may utilize advanced expert systems techniques known to the art which provide learning capabilities and dynamically expanding the database of recognizable shapes. Such dynamic update methods may add unrecognized shapes remaining after the decomposition process, possibly following a connectivity analysis to determine that the unrecognized shape/s create a unique aggregation of a new shape.

If the decomposition process at step 444 fails, the system is adapted to abort the automatic correction program at step 445. A failure of the decomposition process occurs if there are no recognizable shapes detected within the input boundary or if there are too many recognizable shapes above a certain overflow limit. A copy of the complete shapes list is retained at step 446 for subsequent connectivity analysis. Every shape in the recognizable shapes list is analyzed in step 450 to determine if it is truncated by the input area boundary. Each shape that is not truncated is removed from the shapes list. Step 454 checks if the shapes list is empty. If the list is empty, there is no need to adjust the boundary since there are no recognized truncated shapes, and the program ends at step 480.

If step 454 finds that the shapes list is not empty, the program runs a connectivity analysis of each truncated shape in the recognizable shapes list at step 458. Here the program uses the copy of the full recognizable shapes list made at step 446 to determine if the truncated shape is connected to any other shapes within the input area boundary. Truncated shapes that are not connected (like shapes 96 and 98 in FIG. 9A) are removed from the shapes list. If the recognizable shapes list is empty at step 460, the program terminates to step 480.

If the recognizable shapes list is not empty, the program proceeds to adjust the modified boundary along steps 464, and 465. At step 464, the program removes a connected truncated shape from the shapes list and attempts to increase the modified boundary until it encloses the truncated shape. If the currently increased boundary does not reach the end of the virtual display or does not exceed a preset limit, the currently increased boundary replaces the last modified boundary. Otherwise, the last modified boundary is restored and the process continues, recognizing that the just removed shaped will remain truncated. This may result in a partial correction which still achieves the objective to reduce the number of truncated shapes. Step 465 causes step 464 to repeat until the recognizable shapes list becomes empty, so that step 464 may continuously increase the modified boundary to enclose as many truncated and connected shapes as possible.

When the recognizable shapes list is finally empty, step 466 compares the modified boundary and the input area boundary. If the modified boundary remains the same as the input area boundary, the process aborts. If the modified boundary has changed, step 470 displays the larger modified boundary 31 together with the originally selected area 30 in FIG. 9B, and it prompts the user to accept the adjustment of the selected area. If the user rejects the modified boundary at step 474, the program ends at step 480 without adjustment of the selected area. If the user approves the modified boundary, the program replaces the area selection with the modified boundary at step 476 and ends at step 480.

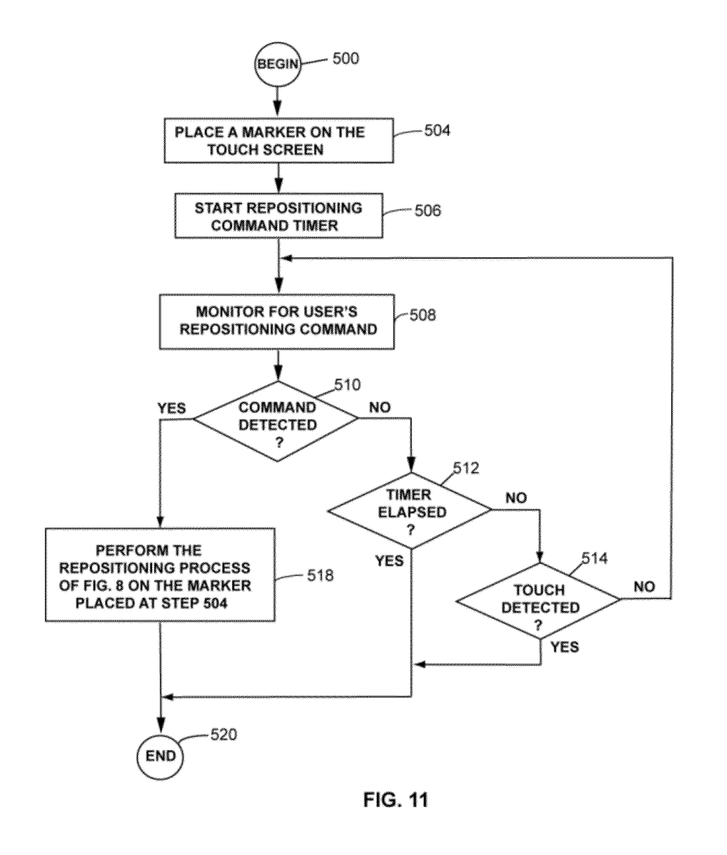

The corner repositioning method described above can be extended for use with any marker placed inaccurately on a hand held device with a touch screen display due to the inherent thickness of the finger tip. FIG. 11 illustrates the flow diagram 500 of the program used to perform such marker repositioning. The program starts at step 504 when a user places a marker on the touch screen display. The process allows a certain period of time following the marker placement for the user to issue a marker repositioning command. The repositioning command can be selected from all available user interface commands, including a movement gesture, a predefined touch gesture, a voice command, a keyboard command, or a predefined visual gesture. The period of time to issue a repositioning command can be defined by activating a reposition command timer at step 506. The system monitors for the user marker repositioning command in step 508. If the user command is detected at step 510, the system proceeds with the corner repositioning process of FIG. 8 (where all references to “corner” are replaced by the placed marker at step 504). The marker is changed to a large crosshair to assist the positioning and alert the user that the repositioning process is on.

If the repositioning command timer expires, the program quits without performing the repositioning. Alternatively, the period of time during which the system waits for the repositioning command may be terminated by a user touch command, detected at step 514. If this alternative approach is taken, the touch command to terminate the period must be different than any touch gesture that may be used for the reposition command. If the marker repositioning command is not a touch gesture, then any touch command detected at step 514 will quit the program without performing the marker repositioning. A combination of both timer expiration and touch termination command can work well with the present invention.

The description above contains many specifications, and for purpose of illustration, has been described with references to specific embodiments. However, the foregoing embodiments are not intended to be exhaustive or to limit the invention to the precise forms disclosed. Therefore, these illustrative discussions should not be construed as limiting the scope of the invention but as merely providing embodiments that better explain the principle of the invention and its practical applications, so that a person skilled in the art can best utilize the invention with various modifications as required for a particular use. It is therefore intended that the following appended claims be interpreted as including all such modifications, alterations, permutations, and equivalents as fall within the true spirit and scope of the present invention.

I claim:

1. A system for selecting an area from a virtual display of a hand held device, comprising:
a processor;
a touch screen display configured to be touched by a user;
a display interface module controlling the operation of said touch screen display and coupled to said processor, said display interface module adapted to display a portion of said virtual display and it is responsive to touch commands, wherein said touch commands are partitioned into a set of view navigation touch commands and a set of all other commands that do not affect view navigation;
a tilt and movement sensor coupled to said processor, said processor is further adapted to perform tilt and movement based view navigation of said virtual display in response to tilt changes and movements of said hand held device;
a storage device coupled to said processor for storing executable code to interface with said touch screen display and said tilt and movement sensor, the executable code comprising:
(a) code for detecting a user command to enter an area selection mode of operation, wherein said set of view navigation touch commands is suspended, and wherein said system is entered into a waiting state for a first touch command;
(b) code for converting a finger touch location on said touch screen display into a corresponding location for an area corner on said virtual display;
(c) code for detecting a first touch command during said waiting state and for selecting a first area corner on said virtual display, wherein the location of said first area corner is converted from the finger touch location of said first touch command using code (b);
(d) view navigation code for tilt and movement based scrolling of said virtual display when said first area corner is selected, said view navigation code further adapted to draw a temporary rectangular boundary on said virtual display, wherein one corner of said boundary is located at said first area corner and the opposite boundary corner is located near the center of said touch screen display;
(e) code for detecting a second touch command when said first area corner is selected and for selecting a second area corner on said virtual display, wherein the location of said second area corner is converted from the finger touch location of said second touch command using code (b); and
(f) code for terminating said area selection mode when said second area corner is selected, wherein said termination code creates a final rectangular boundary of the selected area with opposite corners located at first and second area corners, and wherein said termination code reactivates said set of view navigation touch commands.

2. The system of claim 1, wherein said user command to enter said area selection mode is a predefined touch gesture made with one or more fingers.

3. The system of claim 1, wherein said user command to enter said area selection mode is a movement gesture.

4. The system of claim 1, further comprising a voice interface means for responding to user voice commands, and wherein said user command to enter said area selection mode is a predefined voice command.

5. The system of claim 1, further comprising at least one switching means coupled to said processor, and wherein said user command to enter said area selection mode is activated when said user activates said switching means.

6. The system of claim 1, further comprising a visual gesture detection system coupled to said processor, and wherein said user command to enter said area selection mode is a predefined visual gesture.

7. The system of claim 1, wherein said code (b) converts said finger touch location into an area corner located at the exact touch location on the portion of said virtual display currently shown on said touch screen display.

8. The system of claim 7, wherein said code (b) further comprising a repositioning code to perform a repositioning of the location for said area corner on said virtual display.

9. The system of claim 8, wherein the location for said area corner is marked with an enlarged crosshair marker during said repositioning to alert the user that a corner repositioning mode is active and to enable accurate repositioning.

10. The system of claim 8, wherein said repositioning code is activated when a user initiating a touch command to select an area corner keeps the finger in touch with said touch screen display during said touch command, wherein said repositioning code translates the movement of the finger on said touch screen display into a corresponding movement of said area corner on said virtual display in the same direction of said finger movement, and wherein said repositioning code is further adapted to fix said area corner when the user lifts the finger from said touch screen display.

11. The system of claim 10, wherein said repositioning code places a marker representing said area corner at a displacement above said finger touch location, said displacement is larger than the width of the user's finger, whereby the finger does not obstruct the exact location where the user desires to reposition said area corner.

12. The system of claim 11, wherein said repositioning code translates the length of the movement of the finger into a proportionally smaller length of movement of said displaced area corner on said virtual display whereby relatively large finger movements creates fine movements of the displaced area corner.

13. The system of claim 8, wherein said repositioning code further comprising:
(a) code for setting a corner repositioning mode in response to said touch command;
(b) code for corner movement, in the corner repositioning mode, to move the location of said area corner on said virtual display in response to tilt changes and movements of said hand held device; and
(c) touch detection code, in the corner repositioning mode, to detect any touch command on said touch screen display, wherein the detection of any touch command resets said corner repositioning mode and fixes the current location of said corner point on said virtual display as determined by said corner movement code.

14. The system of claim 13, wherein said code for setting said corner repositioning mode further starts a timer, and wherein said touch detection code is further adapted to reset said corner repositioning mode and fixes the current location of said corner point when said timer expires.

15. The system of claim 1, wherein said virtual display contents is a text, and wherein said code (b) converts said finger touch location into a selected block endpoint location at the inter words space closest to the exact touch location on the portion of said virtual display currently shown on said touch screen display.

16. The system of claim 1, wherein said virtual display contents is a text, and wherein said view navigation translates said tilt changes and movements into a single axis movements to navigate said text file along the characters list of said text.

17. A system for selecting an area from a virtual display of a hand held device, comprising:
a processor;
a touch screen display configured to be touched by a user;
a display interface module controlling the operation of said touch screen display and coupled to said processor, said display interface module adapted to display a portion of said virtual display and it is responsive to touch commands, wherein said touch commands are partitioned into a set of view navigation touch commands and a set of commands that do not affect view navigation;
a tilt and movement sensor coupled to said processor, said processor is further adapted to perform tilt and movement based view navigation of said virtual display in response to tilt changes and movements of said hand held device;
a storage device coupled to said processor for storing executable code to interface with said touch screen display and said tilt and movement sensor, the executable code comprising:
(a) code for setting an area selection mode in response to a first touch gesture command, wherein said set of view navigation touch commands is suspended, and wherein the pattern of said first touch gesture command selects a starting location on said touch screen display;
(b) code for converting a location on said touch screen display into a corresponding area corner located on said virtual display;
(c) code for selecting a first area corner by converting the starting location into a first area corner on said virtual display using code (b);
(d) view navigation code for tilt and movement based scrolling of said virtual display when said first area corner is selected, said view navigation code further adapted to draw a temporary rectangular boundary on said virtual display, wherein one corner of said boundary is located at said first area corner and the opposite boundary corner is located near the center of said touch screen display;
(e) code for detecting a second touch command when said first area corner is selected and for selecting a second area corner on said virtual display, wherein the location of said second area corner is converted from the finger touch location of said second touch command using code (b); and
(f) code for terminating said area selection mode when said second area corner is selected, wherein said termination code creates a final rectangular boundary of the selected area with opposite corners located at first and second area corners, and wherein said termination code reactivates said set of view navigation touch commands.

18. The system of claim 17, wherein said first touch gesture command comprises at least one finger writing of the virtual letter ‘x’ on said touch screen display, and wherein the center point of said virtual letter ‘x’ defines said starting location.

19. The system of claim 17, wherein said code (b) further comprising a repositioning code to perform a repositioning of the location of said area corner on said virtual display.

20. An area selection method for a hand held device with a touch screen display comprising the steps of:
responding to a user initiated start command by setting an area selection mode and placing a first corner for a rectangular selected area on a virtual display shown on said touch screen display;
suspending, in the area selection mode, all view navigation touch screen commands;
navigating the virtual display based on tilt and movement to reach the virtual display portion where the user wishes to place a second corner of said selected area; and
placing said second corner on said virtual display to form a rectangular selected area boundary and to terminate said area selection mode in response to a termination touch command.

21. The method of claim 20, wherein said area selection start command is a touch gesture, said touch gesture defines a gesture location on said touch screen display, and wherein said first corner is placed on a virtual display location corresponding to said gesture location.

22. The method of claim 21, wherein said touch gesture command comprises a finger writing of the virtual letter ‘x’ on said touch screen display, wherein the center of said virtual letter ‘x’ defines said gesture location.

23. The method of claim 20, wherein said start command consists of an area selection mode set command and a first corner selection touch command.

24. The method of claim 23, wherein said area selection mode set command is selected from a group consisting of a movement gesture, a touch gesture, a voice command, a predefined visual gesture, and a switch or keyboard command.

25. The method of claim 23, wherein the step of responding to the user initiated start command further comprising the step of activating a visual indicator to alert the user that the system is waiting for the first corner selection touch command.

26. The method of claim 20, wherein said tilt and movement view navigation is further drawing a temporary rectangular boundary on said virtual display from said first corner to an opposite second corner located near the center of said touch screen display.

27. The system of claim 20, wherein the steps of placing said first and second corners further comprising a repositioning step whereby the user may reposition the corner more accurately on said virtual display.

28. The method of claim 27, wherein said repositioned corner is marked with an enlarged crosshair marker during said repositioning step to alert user that the corner repositioning mode is active.

29. The method of claim 27, wherein said repositioning step is activated when the user initiating said touch command to place a corner keeps the finger in touch with said touch screen display following said touch command, and wherein said repositioning code translates the movement of the finger on said touch screen display into a corresponding movement of said corner on said virtual display in the same direction and distance of said finger movement, said repositioning step is further adapted to fix said corner when the user lifts the finger from said touch screen display.

30. The method of claim 29, wherein said repositioning step is placing a marker representing said corner at a displacement above said finger touch location, said displacement is larger than the width of the user's finger, whereby the finger does not obstruct the exact location where the user desires to reposition said corner point.

31. The method of claim 27, wherein the steps of placing said first and second corners further comprising a repositioning step, wherein said repositioning step further comprising:
setting a corner repositioning mode in response to the touch command for placing said first or second corner, wherein said repositioning mode suspends all view navigation touch commands;
moving said first or second corner on said virtual display, at said corner reposition mode, in response to a tilt and movement based cursor control; and
detecting any touch command on said touch screen display when said corner reposition mode is set, wherein the detection of said touch command fixes the last location of said first or second corner as determined by said tilt and movement based cursor control; and wherein said touch command ends said corner repositioning mode.

32. The method of claim 31, wherein said tilt and movement based cursor control is further adapted to perform fine corner movements in response to user hand movements and tilt changes so that said first or second corner is accurately placed at the exact desired location on said virtual display.

33. The method of claim 31, wherein said setting of said corner repositioning mode starts a timer, and wherein the expiration of said timer ends said corner repositioning mode and fixes the last location of said first or second corners on said virtual display as determined by said tilt and movement based cursor control.

34. The method of claim 20, wherein said virtual display contents is a text file, and wherein said first and second corners are block endpoints, said block endpoints are located at the inter words space closest to the exact touch location on the portion of said virtual display currently shown on said touch screen display.

35. The method of claim 34, wherein the step of navigating the virtual display based on tilt and movement navigates said text file along a single direction corresponding to a linear list of all the characters of the text.

36. A method for boundary adjustment of a user selected display area to reduce the affect of unwanted truncation of contents, the method comprising the steps of:
obtaining an input area boundary from said user selected display area;
decomposing the contents within said input boundary and its immediate surrounding area into a collection of recognizable shapes;
analyzing said collection of recognizable shapes to determine which recognizable shapes are truncated by said input area boundary;
analyzing each truncated recognizable shapes to determine if it is connected to other non-truncated recognizable shapes;
aborting the boundary adjustment if there are no recognizable shapes that are truncated and connected;
creating a modified area boundary that is larger than said input area boundary so that it reduces the number of recognizable shapes that are truncated and connected; and
prompting the user to select between said input area boundary and said modified area boundary.

37. The method of claim 36, wherein said decomposition step employs a database of recognizable shapes comprising geometrical shapes and a plurality of complex shapes to be compared to said contents of said input area boundary.

38. The method of claim 37, wherein said database of recognizable shapes is dynamically updated to add unrecognized shapes as they are decomposed from said contents.

39. A method for a marker repositioning on a touch screen display of a hand held device comprising the steps of:
placing a marker on said touch screen display in response to a user command;
detecting a user command to enter a marker repositioning mode during a period of time from said marker placement;
setting a marker repositioning mode in response to said user command;
moving said marker on said display exclusively in response to a tilt and movement based cursor control when said marker reposition mode is set; and
detecting any touch command on said touch screen display when said marker reposition mode is set, wherein the detection of said touch command fixes the last location of said marker as determined by said cursor control, and wherein said touch command terminates said marker repositioning mode.

40. The method of claim 39, wherein said user command to enter marker repositioning is selected from a group consisting of a movement gesture, a touch gesture, a voice command, a predefined visual gesture, and a switch or keyboard command.

41. The method of claim 39, wherein said period of time from said marker placement is determined by a timer set to a preset value, and wherein the expiration of said timer preserves the original place of said marker without performing said marker repositioning.

42. The method of claim 39, wherein said period of time from said marker placement is terminated when a user makes a quit touch command on said touch screen display, wherein said quit touch command is different than a touch gesture that may be used for said user command to enter a marker repositioning mode.

43. The method of claim 39, wherein said marker is changed to a large crosshair marker when said marker repositioning mode is set.
